(19) United States
(12) Patent Application Publication
(10) Pub. No.: US 2026/0326014 A1
(43) Pub. Date: Oct. 22, 2026

(54) LOW-ENERGY MARITIME DIRECT AIR CAPTURE AND OCEAN CARBON SEQUESTRATION SYSTEM

(71) Applicant: KOREA INSTITUTE OF OCEAN SCIENCE & TECHNOLOGY, Busan (KR)

(72) Inventors: Hee Jin KANG, Gyeryong-si (KR); Jang Pyo HONG, Daejeon (KR)

(21) Appl. No.: 19/233,664

(22) Filed: Jun. 10, 2025

(30) Foreign Application Priority Data
Apr. 18, 2025 (KR) 10-2025-0050932

(51) Int. Cl. B01D 53/02; B01J 20/34; C02F 1/461

(52) U.S. Cl. CPC B01D 53/02; B01J 20/3483; C02F 1/461; B01D 2253/1122; B01D 2253/20; B01D 2257/504; C02F 2209/003; C02F 2209/06

(57) ABSTRACT

An energy-saving offshore direct air capture and ocean carbon sequestration system may include an air inlet with an opening facing a wind direction to allow external air to enter the system through headwinds while the vessel is sailing. The air inlet may be connected to a regeneration chamber that receives external air. The regeneration chamber may include an adsorbent module that captures CO2 from the incoming air. The system may also include an alkali injection device, a reaction unit that stores some ballast water and receives CO2 captured from the regeneration chamber and alkali substances from the alkali injection device. The system may further include a ballast water tank that receives CO2-infused ballast water, an electrolytic ballast water treatment device that neutralizes the CO2-infused ballast water in the ballast water tank, a water quality sensor module that measures the acidity of the CO2-infused ballast water in the ballast water tank.

### CROSS REFERENCE TO RELATED APPLICATION

The present application claims priority to Korean Patent Application No. 10-2025-0050932 filed on Apr. 18, 2025, the entire contents of which are incorporated herein for all purposes by this reference.

### BACKGROUND

### Technical Field

The present disclosure relates to an energy-saving offshore direct air capture and ocean carbon sequestration system.

### Description of Related Technology

Conventional carbon capture technologies are mainly limited to land-based stationary facilities and are difficult to apply to mobile platforms such as ships, or they consume excessive energy, thus posing limitations for commercial application.

### SUMMARY

One aspect is an energy-saving offshore direct air capture and ocean carbon sequestration system that captures CO₂ from the air using headwinds during ship navigation and dissolves the captured CO₂ into seawater by utilizing the ship's ballast water.

Another aspect is an energy-saving offshore direct air capture and ocean carbon sequestration system.

Another aspect is an energy-saving offshore direct air capture and ocean carbon sequestration system that comprises: an air inlet portion installed such that its opening faces the wind direction, including the bow of the ship, and allowing external air to be introduced inside by means of the headwind during navigation of the ship, a regeneration chamber connected to the air inlet portion and receiving external air introduced through the air inlet portion, an adsorbent module installed inside the regeneration chamber for capturing CO₂ from the air, an alkali injection device for supplying an alkali substance, a reaction unit that stores part of the ballast water, receives the captured CO₂ from the regeneration chamber via piping, and is supplied with the alkali substance from the alkali injection device, a ballast water tank connected to the reaction unit and receiving the ballast water into which CO₂ has been injected from the reaction unit, an electrolytic ballast water treatment device for neutralizing the CO₂-injected ballast water in the ballast water tank, a water quality sensor module for measuring the acidity of the CO₂-injected ballast water in the ballast water tank; and, a control device for discharging the ballast water to the outside ocean of the ship through an outlet of the ballast water tank when the measured acidity satisfies a preset reference value indicating that the ballast water has been neutralized.

The adsorbent included in the adsorbent module is composed of an amine-based or Cu²⁺ complex-based solid adsorbent.

The energy-saving offshore direct air capture and ocean carbon sequestration system further comprises a waste heat recovery device connected to the funnel of the ship, which recovers waste heat from the engine and generator of the ship through the funnel and supplies the recovered waste heat to the regeneration chamber.

The regeneration chamber regenerates the adsorbent by separating the captured CO₂ from the saturated adsorbent in the adsorbent module using the waste heat.

In the reaction unit, the supplied CO₂ is injected into the ballast water and dissolved, and is stabilized by chemically bonding with the supplied alkali substance.

The alkali substance is NaOH or Ca(OH)₂, and the NaOH or Ca(OH)₂ is stabilized by bonding with the CO₂ to form NaHCO₃ or CaCO₃.

The electrolytic ballast water treatment device removes residual alkali substances and copper ions eluted from the catalyst in the CO₂-injected ballast water of the ballast water tank.

The energy-saving offshore direct air capture and ocean carbon sequestration system according to an embodiment of the present disclosure captures CO₂ from the air using headwinds during ship navigation and dissolves the captured CO₂ into seawater using the ship's ballast water, thereby serving as a marine carbon neutrality technology with higher energy efficiency and lower cost compared to conventional land-based direct air capture systems.

Furthermore, in addition to its value as a response measure to international greenhouse gas emission regulations for ships, such as those by the IMO, it also offers potential for economic utilization in the carbon emissions trading market, and possesses high commercial scalability through integration with future autonomous ship and eco-friendly ship technologies.

### BRIEF DESCRIPTION OF THE DRAWINGS

FIG. 1 is a diagram schematically illustrating the configuration of an energy-saving offshore direct air capture and ocean carbon sequestration system according to an embodiment of the present disclosure.

FIG. 2 is a diagram schematically illustrating the application of the energy-saving offshore direct air capture and ocean carbon sequestration system of FIG. 1 to a ship, according to an embodiment of the present disclosure.

### DETAILED DESCRIPTION

The process of collecting air using a fan during carbon capture requires high driving power, and the storage and handling of CO₂ after capture is difficult, resulting in technical challenges that hinder economic feasibility.

Accordingly, it was intended to capture air without a fan in the windward area encountered during navigation by utilizing a ship, which is a large structure sailing on the sea, and to dissolve the captured CO₂ into the ocean through neutralization. In this process, in order to ensure high carbon capture efficiency, copper components applied to the adsorbent or substances such as NaOH used in the process of neutralizing CO₂ into bicarbonate may cause marine pollution, thereby requiring a technical solution to this issue.

Singular expressions used herein include plural expressions unless the context clearly indicates otherwise. In the present specification, terms such as “comprise” or “include” should not be construed as necessarily including all of the various components or steps described herein, but should be construed such that some of the components or steps may not be included or additional components or steps may be further included. In addition, terms such as “ . . . part” and “module” described herein refer to a unit that processes at least one function or operation, which may be implemented in hardware or software, or in a combination of hardware and software.

Hereinafter, various embodiments of the present disclosure will be described in detail with reference to the accompanying drawings.

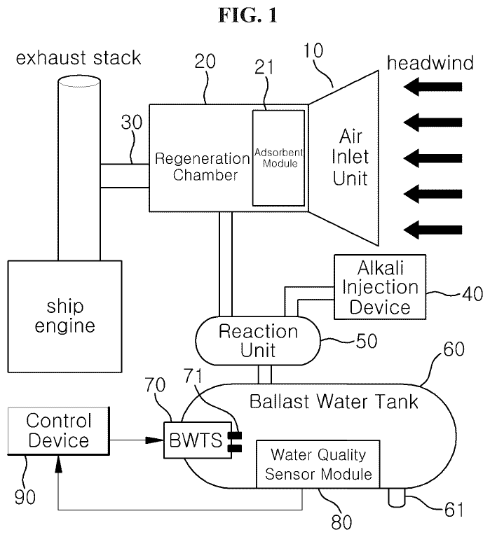

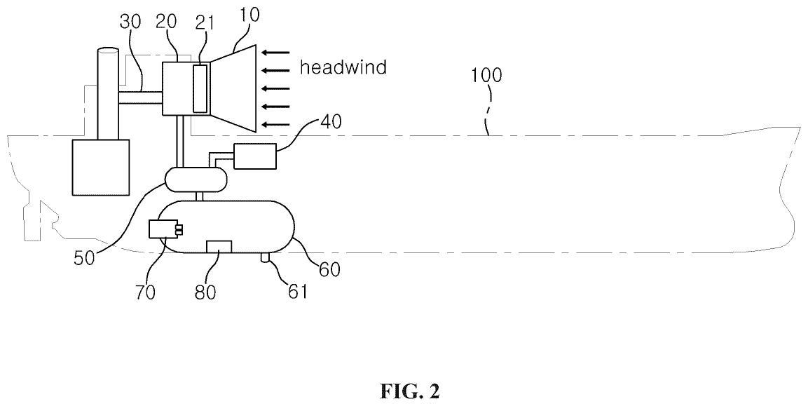

FIG. 1 is a diagram schematically illustrating the configuration of an energy-saving offshore direct air capture and ocean carbon sequestration system according to an embodiment of the present disclosure, and FIG. 2 is a diagram schematically illustrating the application of the energy-saving offshore direct air capture and ocean carbon sequestration system of FIG. 1 to a ship, according to an embodiment of the present disclosure. Hereinafter, with reference to FIGS. 1 and 2, the energy-saving offshore direct air capture and ocean carbon sequestration system according to an embodiment of the present disclosure will be described.

Referring to FIGS. 1 and 2, the energy-saving offshore direct air capture and ocean carbon sequestration system according to an embodiment of the present disclosure may include: an air inlet unit (or an air inlet) 10, a regeneration chamber 20, an adsorbent module 21, a waste heat recovery device 30, an alkali injection device 40, a reaction unit (or a reactor) 50, a ballast water tank 60, an electrolytic ballast water treatment device 70, a water quality sensor module (or a water quality sensor) 80, and a control device (or a controller) 90.

The air inlet unit 10 is installed such that its opening faces the wind direction, including the bow of the ship 100, allowing outside air to be drawn into the system by headwinds during the ship's navigation.

The regeneration chamber 20 is connected to the air inlet unit 10 and receives the outside air introduced through the air inlet unit 10.

Here, an adsorbent module 21 is installed inside the regeneration chamber 20, and it can be arranged in such a way that the outside air introduced through the air inlet unit 10 is directly delivered to it.

Through this configuration, the adsorbent module 21 captures CO₂ from the incoming air, allowing for efficient atmospheric CO₂ capture without the need for an additional fan.

For example, the adsorbent included in the adsorbent module 21 may be composed of an amine-based or Cu²⁺ complex-based solid adsorbent.

Furthermore, the regeneration chamber 20 regenerates the adsorbent by separating the captured CO₂ from the saturated adsorbent in the adsorbent module 21 using the waste heat from the ship's 100 engine and generator.

The waste heat recovery device 30 is connected to the funnel of the ship 100 and recovers waste heat from the ship's engine and generator through the funnel, supplying the recovered waste heat to the regeneration chamber 20.

For example, the regeneration chamber 20 may use steam heated to a temperature of 80-120 °C by the waste heat supplied from the waste heat recovery device 30 to separate CO₂ from the adsorbent, thereby regenerating the adsorbent.

The alkali injection device 40 supplies an alkaline substance to the reaction unit 50.

For example, the alkaline substance may include NaOH or Ca(OH)₂.

The reaction unit 50 is connected to the ballast water tank 60, storing a portion of the ballast water. It receives the CO₂ captured from the regeneration chamber 20 via piping and the alkaline substance from the alkali injection device 40.

Here, the supplied CO₂ is injected into the ballast water and becomes solubilized, then chemically binds with the alkaline substance and becomes stabilized.

For instance, the alkaline substances NaOH or Ca(OH)₂ may bind with CO₂ to form NaHCO₃ or CaCO₃ for stabilization.

The ballast water tank 60 stores ballast water and receives the CO₂-injected ballast water from the reaction unit 50.

The electrolytic ballast water treatment device 70 uses a pair of electrodes 71 to remove residual alkaline substances (e.g., NaOH) and copper ions (Cu²⁺) eluted from catalysts in the CO₂-injected ballast water of the ballast water tank 60.

This process minimizes the environmental impact of discharging the treated ballast water into the ocean.

The water quality sensor module 80 measures the acidity (pH) of the CO₂-injected ballast water in the ballast water tank 60.

The control device 90 discharges the ballast water from the ballast water tank 60 to the external ocean via the discharge outlet 61 of the ship 100 when the measured acidity satisfies a preset threshold, indicating that the ballast water has been neutralized.

The embodiment of the present disclosure described above is disclosed for illustrative purposes only, and various modifications, alterations, and additions may be made by those skilled in the art within the spirit and scope of the present disclosure. Such modifications, alterations, and additions should be considered to fall within the scope of the following claims.

What is claimed is:

1. An energy-saving offshore direct air capture and ocean carbon sequestration system, comprising:
an air inlet comprising an opening configured to face a wind direction including a bow of a ship, allowing external air to be introduced inside through headwinds during the navigation of the ship;
a regeneration chamber connected to the air inlet and configured to receive external air introduced through the air inlet;
an adsorbent module disposed inside the regeneration chamber and configured to capture CO₂ from the air;
an alkali injection device configured to supply an alkali substance;
a reactor configured to store part of ballast water, receive the captured CO₂ from the regeneration chamber via piping, and receive the alkali substance from the alkali injection device;
a ballast water tank connected to the reactor and configured to receive the ballast water into which CO₂ has been injected from the reactor;
an electrolytic ballast water treatment device configured to neutralize the CO₂-injected ballast water in the ballast water tank;
a water quality sensor configured to measure an acidity of the CO₂-injected ballast water in the ballast water tank; and
a controller configured to discharge the ballast water to the outside of an ocean on which the ship is located through an outlet of the ballast water tank in response to the measured acidity satisfying a preset reference value, indicating that the ballast water has been neutralized.

2. The system of claim 1, wherein the adsorbent module comprises an amine-based or Cu²⁺ complex-based solid adsorbent.

3. The system of claim 1, further comprising a waste heat recovery device connected to a funnel of the ship, and configured to recover waste heat from an engine and a generator of the ship through the funnel, and supply the recovered waste heat to the regeneration chamber.

4. The system of claim 3, wherein the regeneration chamber is configured to regenerate the adsorbent by separating the captured CO₂ from a saturated adsorbent of the adsorbent module using the waste heat.

5. The system of claim 1, wherein, in the reactor, the supplied CO₂ is configured to be injected into the ballast water and dissolved, and stabilized by chemically binding with the supplied alkali substance.

6. The system of claim 1, wherein the alkali substance is NaOH or Ca(OH)₂ configured to be stabilized by binding with CO₂ to form NaHCO₃ or CaCO₃.

7. The system of claim 1, wherein the electrolytic ballast water treatment device is configured to remove residual alkali substances and copper ions eluted from catalysts in the CO₂-injected ballast water of the ballast water tank.
